(19) United States
(12) Patent Application Publication
(10) Pub. No.: US 2006/0020544 A1
(43) Pub. Date: Jan. 26, 2006

(54) System and method for tracking emissions

(75) Inventor: Joseph G. Kaveski, Leawood, KS (US)

Correspondence Address: FOLEY & LARDNER LLP, 777 EAST WISCONSIN AVENUE, SUITE 3800, MILWAUKEE, WI, 53202-5308, US

(73) Assignee: Johnson Controls Technology Company

(21) Appl. No.: 10/898,719

(22) Filed: Jul. 23, 2004

(51) Int. Cl. G06Q 40/00

(52) U.S. Cl. 705/40

(57) ABSTRACT

A system for estimating emissions based on bills paid through a bill paying service. The system includes a bill payment processor configured to receive a bill for an external entity and arrange for a payment based on the bill, an emission estimation engine configured to generate an emissions estimate based on the bill, and a reporting engine configured to provide the emission estimate.

### BACKGROUND OF THE INVENTION

The present invention relates generally to the field of systems and methods for tracking emissions. More particularly, the present invention relates to a system and method for providing an emissions estimate based on utility bills being paid through a bill paying service.

Companies are becoming increasingly aware of issues associated with emissions, particularly greenhouse gases (GHG) emissions. Companies also realize that managing emissions requires tracking the emissions accurately, both for the whole company and at any given location. Similarly, stakeholders (e.g., shareholders, government initiatives, non-governmental organizations (NGO), etc.) also are increasingly interested in having efficient systems and methods to track the performance of companies in managing greenhouse gases. These internal and external needs have led to greater interest in standards for measuring emissions and reporting mechanisms that are managed or verified by third parties.

Accordingly, companies are increasingly seeking easy and reliable systems and methods for estimating or measuring emissions. One such method includes estimating emissions based upon consumption of a consumable resource, such as fuel, natural gas, electricity, etc. Emissions may be estimated by tracking the consumption of consumable resources at a given location, company-wide, etc. An estimated amount of emissions may be calculated based on the amount of consumption that occurs at each location associated with a company, estimated amount for each location may then be aggregated to estimate total emissions company-wide.

The amount of consumption for a company or a location may be tracked by reviewing bills that are paid for the resource consumption, such as a bill to a utility company. The bill will generally include a measurement of the amount of the resource that was consumed at the location. However, a company with multiple locations likely receives many different bills from different resource providers at their various locations, many of these resource providers present information in different formats, using different measurement standards, and so forth, making consistent measurement of resource consumption difficult.

What is needed is a system and method for generating an emissions report based on standardized, aggregated, and verified bills for consumption. What is further needed is such a system and method configured to generate the emissions report to include an estimate of the amount of greenhouse gases being produced.

### SUMMARY OF THE INVENTION

One embodiment of the invention relates to a system for estimating emissions based on bills paid through a bill paying service. The system includes a bill payment processor configured to receive a bill for an external entity and arrange for a payment based on the bill, an emission estimation engine configured to generate an emissions estimate based on the bill, and a reporting engine configured to provide the emission estimate.

Another embodiment of the invention relates to a method for generating an emissions estimate based on a bill paid through a bill paying service. The method includes receiving a bill at a bill paying service, arranging for payment of the bill, and generating an emissions estimate based on the bill.

Other features and advantages of the present invention will become apparent to those skilled in the art from the following detailed description and accompanying drawings. It should be understood, however, that the detailed description and specific examples, while indicating preferred embodiments of the present invention, are given by way of illustration and not limitation. Many modifications and changes within the scope of the present invention may be made without departing from the spirit thereof, and the invention includes all such modifications.

### BRIEF DESCRIPTION OF THE DRAWINGS

FIG. 1 is a block diagram illustrating an emissions estimate system for a company having multiple locations served by multiple resource providers (e.g. utility companies), according to an exemplary embodiment; and

FIG. 2 is a flowchart illustrating a method for generating an emissions estimate for one or more locations through a bill paying service, according to an exemplary embodiment.

### DETAILED DESCRIPTION OF THE PREFERRED EMBODIMENTS

In the following description, for the purposes of explanation, numerous details are set forth in order to provide a thorough understanding of the present invention. It will be evident to one skilled in the art, however, that the exemplary embodiments may be practiced without these specific details. In other instances, structures and devices are shown in diagram form in order to facilitate description of the exemplary embodiments. Furthermore, while the exemplary embodiments are often described in the context of tracking emissions based on utility bills provided by a utility provider, it should be understood that the disclosed method of and apparatus for estimating emissions may be used to estimate emissions based on estimated or actual emissions produced due to the consumption of any type of consumable resource.

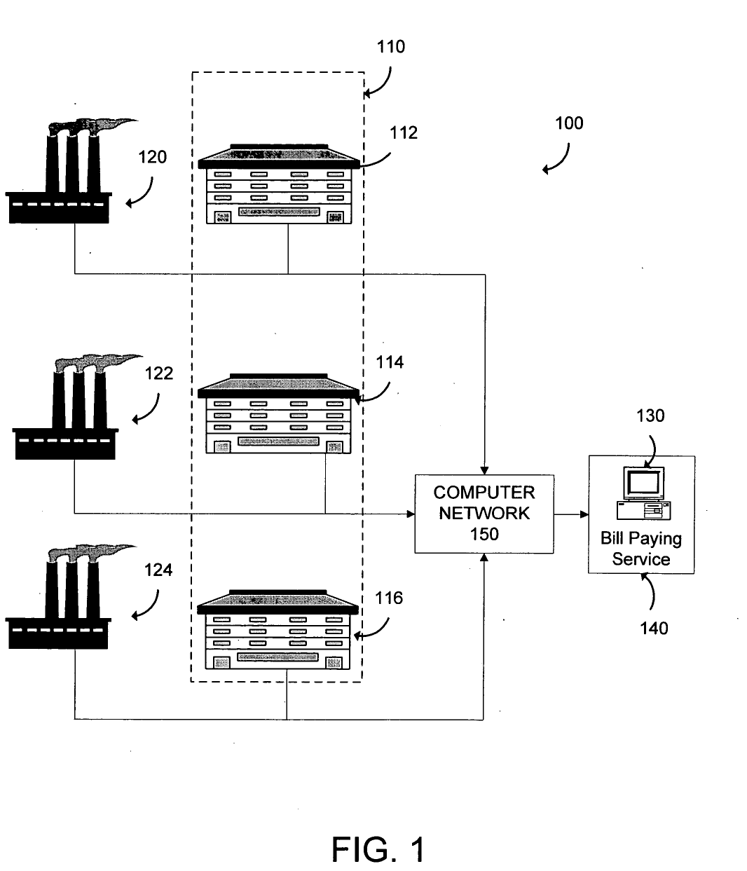

Referring to FIG. 1, a block diagram 100 illustrating an emissions estimation engine 130 provided by a bill-paying service 140 for a company 110 is shown, according to an exemplary embodiment. Company 110 includes locations 112, 114, and 116 served by utility providers 120, 122, and 124. Company 110 is configured to utilize emissions estimation engine 130 to estimate emissions for each of locations 112, 114, and 116 and for company 110 as a whole.

Company 110 may be any type of company desiring to track emissions from one or more of locations 112, 114 and 116. Emissions to be tracked may include all emissions, emissions of a particular type, such as greenhouse gases, emissions of specific compositions, such as CO₂, methane, nitrous oxide, hydroflourocarbons, perfluorocarbons, sulfur hexafluoride, etc., or any other type of emission.

Company 110 includes locations 112, 114 and 116. Although three locations are shown, it is understood that company may include more or fewer locations. Each location may be any of a variety of different types of location. For example, according to an exemplary embodiment, location 112 may be a manufacturing location, location 114 may be an office location, and location 116 may be an assembly location. According to alternative. embodiment, locations may be any location using energy resources such as gas or electricity, that directly or indirectly result in emissions, associated with company 110. For example, locations may include other sources of emissions, for example on-site power plants, vehicles, farming sites, mobile sites, manufacturing processes, etc.

Each of locations 112, 114 and 116 may be associated with one or more utility providers 120, 122, and 124. The utility providers include any of the variety of different types of utility provider that provide a consumable resource to company 110. For example, according to an exemplary embodiment, utility provider 120 may be an electricity provider, utility provider 122 may be a natural gas provider, and utility provider 124 may be a fossil fuel provider. The consumable resource may include any resource which may be related to an emissions output for the location. Further examples of utility providers may include gasoline providers, farming chemical providers, animal feed providers, etc. According to alternative embodiments, multiple locations may be associated with a single utility provider, multiple utility providers may be associated with a single location, etc.

Each of locations 112, 114 and 116 may be configured to consume a resource provided by their associated utility providers. Consumption may include use of purchased electricity, such as for providing lighting, power machinery, etc. or combustion of fossil fuels, such as burning of coal, natural gas and petroleum. Some of these locations may include fossil fuel combustion from stationary sources such as electricity generators. While others are associated with combustion of fossil fuels by mobile sources, such as automobiles, jets, etc. The energy that is consumed may be tracked by the utility provider such that a utility bill for the consumption of the resource may be generated and periodically sent to company 110 or some other party. The utility bill may indicate the number of units of energy that were consumed at a location and the amount that is owed for each unit of energy that was consumed. For example, utility provider 120 may be configured to provide electricity to location 112. Utility provider 120 may further be configured to track the number of kilowatt-hours that are consumed at location 112 and send a monthly utility bill to company 110 based on the number of kilowatt-hours that were consumed at location 112.

The consumption of resources at a location may be associated with an emission estimate that is generated for each unit of the consumable resource consumed. The emission amount may be determined by multiplying the number of units of the consumable resource with an emissions factor representative of the amount of emissions produced per unit of the consumable resource. For example, according to the U.S. Energy Information Administration, the emission factor for gasoline is 19.564 pounds of carbon dioxide produced per gallon of gasoline used. The estimate of the amount of emission that is generated for each unit of energy consumed, hereinafter the emissions factor, may be calculated based on empirical and/or theoretical data. Each consumable resource may be associated with a different emissions factor. For example, gasoline may have a first emissions factor, electricity a second emissions factor, etc. The electricity emissions factor is in turn based on the type of operation utilized to produce the electricity, such as nuclear, coal, natural gas, etc., all of which have different emissions. Further, each location may further modify the emissions factor based on properties associated with the location. For example, a factory may include scrubbers that reduce the amount of emissions that would normally be produced, a vehicle may include special filters, etc. A company may have emissions factors calculated by a reputable organization and updated regularly to show improvements to individual utility locations.

Each emission factor is generally associated with a specific type of emission as well as with a consumable resource. For example, a single emission factor may be for a particular emissions types, such as CO₂, as well as a single consumable resource, such as gasoline. In other words, one emissions factor may be used to calculate the amount of CO₂ emitted while burning a gallon of gasoline while a second emissions figure may be used to calculate the amount of CO₂ emitted while burning a gallon of natural gas.

Although consumption has been described with reference to an amount of a consumable resource provided by a utility provider, consumption may alternatively be calculated based on an amount of actual activity. An example may include a determination of the number of miles driven by a vehicle. The emission amount may be determined based on a calculation of the number of miles driven divided by the number of miles per gallon times the emissions factor. Alternative examples may include operating hours for machinery, a level of production, etc. The activity level may further be associated with a bill to be paid by bill paying service 140. For example, the vehicle may be a leased or rented vehicle for which a bill is sent to bill paying service 140 based on the number of miles driven.

Utility providers 120, 122 and 124 may provide company 110 with a utility bill based on the amount of consumable resources provided. However, each utility provider may be in a different geographic location, including different countries, may be separately owned and managed, may be subject to unique laws or regulations, etc. Accordingly, the utility bills that are provided by utility providers 120, 122 and 124 may be generated according to a variety of different standards. For example, one electricity provider may provide a bill based on the number of kilowatt-hours that were consumed while another electricity provider may provide a bill based on the numbers of megajoules consumed. Further, the utility providers may be geographically dispersed and provide bills directly to each location, making centralized data gathering difficult. Aggregating, standardizing and paying the utility bills may prove challenging for company 110.

Accordingly, company 110 may utilize bill-paying service 140 to track and pay the utility bills generated by utility providers 120, 122, and 124. The utility bills may be forwarded to bill paying service 140 by company 110 or automatically sent to bill paying service 140 by the utility providers. According to an alternative embodiment, utility bills may be accessed by bill paying service 140 at company 110, at each location 112, 114 and 116, or at utility providers 120, 122 and 124 through a computer network 150. Computer network 150 may be any network of computers that are coupled to allow the exchange of data. According to an exemplary embodiment, computer network 150 is the Internet. Advantageously, where the utility bills are received or accessed through bill paying service 140, a single point is used to collect all of the relevant data, reducing data entry errors.

Although bill paying service 140 is described herein as a bill paying service, according to alternative embodiments, the functions associated with the tracking, standardizing, aggregating, verifying, etc. of the utility bills may alternatively be performed by a data warehousing system. The data warehousing system may be combined with the emissions estimate engine 130 to perform the functions described herein.

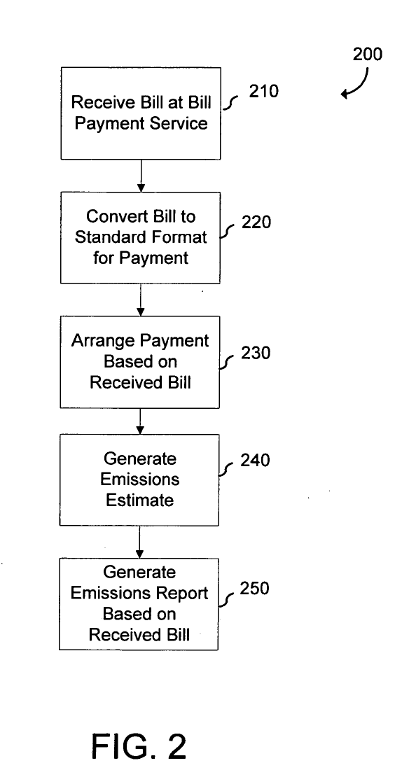

Utility bills that are received by bill-paying service are often not in a single standard format, as described above. The utility providers generating the utility bills may be located in different geographic location, different countries, different markets, etc. and may structure their bills based on these factors. Accordingly, bill paying service 140 may be configured to standardize the bills that are received from the utility providers and/or company 110. Advantageously, where the utility bills are received in electronic form over computer network 150, the data can be automatically converted to a particular standard and aggregated with other data for company 110 without human intervention, reducing workload and the occurrence of errors.

Where company 110 utilizes bill-paying service 140 for the payment of all of the utility bills provided by utility providers 120, 122 and 124, bill paying service 140 is able to generate a record of the resources that are consumed by company 110. This record of consumed resources may be utilized to calculate an estimate of the total emissions produced by company 110, as will be further discussed below with reference to FIG. 2.

Advantageously, the estimated emissions may be utilized to comply with governmental environmental regulations and policies, shareholder resolutions, NGO initiatives, corporate transparency regulations, etc. Further, the estimated emissions may serve a business need, such as for permit trading systems, emissions trading (e.g. selling credits for emissions where efficiencies have reduce emissions below a baseline), carbon and energy taxes, etc.

Referring now to FIG. 2, a flowchart 200 illustrating a method for generating an emissions estimate for one or more locations through a bill paying service is shown, according to an exemplary embodiment. Bill paying service 140 may be configured to perform the method described herein in combination with emissions estimation engine 130. Although specific steps are shown and described in a specific order, it is understood that the method may include more, fewer, and/or a different sequence of steps to perform the functions described herein.

In a step 210, a utility bill is received by bill paying service 140 for company 110. Preferably, the utility bill is received electronically through computer network 150 from a utility provider. Alternatively, the utility bill may be communicated through any number of channels in any form for receipt by bill paying service 140. Upon receipt, the utility bill may be converted into an electronic format. Preferably, bill paying service 140 may include one or more functions to verify the validity of the information contained in the received utility bill.

Preferably, the utility bill includes an indication of the amount of each consumable resource offered by the utility provider that was consumed by one or more locations associated with company 110. For example, where the utility provider provides both electricity and natural gas, the utility bill may provide an indication of the number of kilowatt-hours of electricity that were sold to a location as well as the volume of natural gas that was sold to a location. Where a single utility provider provides resources to more that one location of company 110, the resources consumed are preferably divided based on consumption at each location.

Receipt of the utility bill may further included additional processing associated with the receipt, such as scanning and providing a bar code for the invoices, data entry where the invoice is not in an electronic format, error checking, validation and variance checking, etc. Variance checking may include reviewing a prior balance, reviewing for duplicate bills, identifying missed consumption periods, identifying out-of-sequence meter read dates, comparing bill total to sum of line items, identifying utility vendor, account number, etc., verifying late fees on the bill, comparing the dates on the bill for consistency, etc.

Following receipt of the utility bill, the information in the utility bill may be reviewed to determine whether the data in the utility bill is accurate and in a standard format in a step 220. The standard format may be determined based on a variety of factors such as the format preferred by company 110, the most frequently used format, a format mandated by government regulation, etc. If the data is not in the standard format, a special template may be used to standardize the data. For example, some utilities have different labels for the same information. The template ensures that the data from the utility bill is entered into the right “field”. Additionally, the data may be converted using standard energy conversion formulas. For example, where kilowatt-hours is a preferred standard format for units of energy and a utility bill is received that indicates units of energy consumed in mega joules, the number of mega joules consumed may be divided by 3.6 to calculate the equivalent number of kilowatt-hours. Standardizing the utility bill information may further include other functions such as allocating units consumed based on known activity at a location, etc. Advantageously, where the data in the utility bill is in electronic form, the conversions may be automatically be performed by a computing system associated with bill paying service 140.

The data received in the utility bill may further be incorporated in a resource consumption record associated with company 110. The resource consumption record may be a record of all resource consumption for company 110. The record may be organized according to any desirable criteria such as location, region, business unit, utility provider, consumable resource, etc.

After the utility bill has been received and standardized, bill paying service 140 may be configured to arrange for payment of the utility bill in a step 230. Payment can include paying from an account associated with company 110 or otherwise arranging the transfer of finds to pay the utility bill on behalf of company 110.

Emissions estimation engine 130 may be configured to utilize the data received in the utility bill to determine emissions that may be associated with the resource consumption shown in the utility bill in a step 240. For example, where the utility bill is a gasoline bill and the location is a motor vehicle. The emissions factor for that vehicle may be calculated based on actual emissions for the vehicle, estimated emissions for the vehicle, actual or estimated emissions for the gasoline, etc. The emissions factor can then be multiplied by the amount of gasoline utilized to determine the amount of emissions that were produced based on the units consumed as shown on the utility bill.

Each emissions factor is associated with an emission of a particular type, such as CO₂ or CO₂ equivalents. Accordingly, step 240 may be repeated for each emission type that is of interest, using the emission factor associated with each emission type.

The calculated emissions may be stored in an aggregate emissions record for company 110. The aggregate emissions record may be searchable by any of a variety of search criteria such as location, utility resource type, emission type, etc.

The calculated emissions may be reported to company 110 in a step 250. Reporting emissions includes reporting the emissions in any desirable format as indicated by company 110. The emissions may be reported to company 1 10 based upon receipt of the utility bill, based on payment of the utility bill, periodically, etc. The emissions report may be sent to company 110, displayed in a secure web interface, or provided according to any other reporting method. Advantageously, the aggregate data may be provided in a single location for company 110 facilitating review of current levels, trends, etc.

Yet further, the aggregate data may be used to set an emission baseline and the set reduction goals based on the emission baseline. The aggregate data may be compared present actual emissions to the baseline to show present levels. The aggregate data may further be archived and later retrieved to show progress toward an emission reduction goal. This data can further be used to forecast future emissions based on trends in the present and archived data. This data may be modified to include projected effects on emissions based on future emission reduction projects.

The steps described herein may be performed by a computing system, a human operator, or some combination thereof. The computing system may be any standard computing system including input and output device, memory, a processor, etc. Preferably, the computing system may be connected to computer network 150 to communicate direct with utility providers 120, 122 and 124 and company 110.

Advantageously, the emission estimation provided by bill paying service 140 using emissions estimation engine 130 is scalable according to the needs and composition of company 110. For example, new locations, utility providers, or any other factors may easily be added, removed, and/or changed based on the needs of company 110. Further, estimation engine 130 may be customized to a greater or lesser degree based on company 110. For example, the emissions factor associated with each location may be customized based on actual emissions from that location or a generic average emissions factor may be utilized.

According to yet another advantage, emissions estimation engine 130 in combination with bill paying service 140 allows company 110 to eliminate the need for extra effort involved with copying and manually entering a utility bill into emissions reporting engine 130. Further, the records provided by bill paying service 140 protect the integrity of the data that is reported, providing an audit trail using measuring such as the scanning and bar coding of the utility bills as described above.

It should be understood that the construction and arrangement of the elements of the exemplary embodiments are illustrative only. Although only a few embodiments of the present invention have been described in detail in this disclosure, many modifications are possible without materially departing from the novel teachings and advantages of the subject matter recited in the claims. Accordingly, all such modifications are intended to be included within the scope of the present invention as defined in the appended claims. Unless specifically otherwise noted, the claims reciting a single particular element also encompass a plurality of such particular elements. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions may be made in the design, operating conditions and arrangement of the exemplary embodiments without departing from the spirit of the present invention as expressed in the appended claims.

What is claimed is:

1. A system for estimating emissions based on bills paid through a bill paying service, comprising:
a bill payment processor configured to receive a bill for an external entity and arrange for a payment based on the bill;
an emission estimation engine configured to generate an emissions estimate based on the bill; and
a reporting engine configured to provide the emission estimate.

2. The system of claim 1, wherein the bill is based on an amount of a consumable resource provided to a location.

3. The system of claim 2, wherein the emissions estimate is generated by multiplying an emissions factor with the amount of the consumable resource provided to the location.

4. The system of claim 3, wherein the emissions factor is based on one or more characteristics of the location.

5. The system of claim 3, wherein the emissions factor is based on the type of the consumable resource.

6. The system of claim 5, wherein the emissions factor is an amount of greenhouse gases produced for every unit of the consumable resource that is consumed.

7. The system of claim 1, where the reporting engine includes a web-based interface configured to display the emissions estimate.

8. The system of claim 1, wherein the emissions estimation engine is further configured to generate a baseline value based on the emission estimate.

9. The system of claim 8, wherein the emissions estimation engine is further configured to generate a comparison between the emissions estimate and a baseline.

10. The system of claim 8, wherein the emissions estimation engine is further configured to generate a reduction goal based on the emissions estimate and a baseline.

11. A method for generating an emissions estimate based on a bill paid through a bill paying service, comprising:
receiving a bill at a bill paying service;
arranging for payment of the bill; and
generating an emissions estimate based on the bill.

12. The method of claim 11, wherein the bill is based on an amount of a consumable resource provided to a location.

13. The method of claim 12, wherein the emissions estimate is generated by multiplying an emissions factor with the amount of the consumable resource provided to the location.

14. The method of claim 13, wherein the emissions factor is based on one or more characteristics of the location.

15. The method of claim 13, wherein the emissions factor is based on the type of the consumable resource.

16. The method of claim 15, wherein the emissions factor is an amount of greenhouse gases produced for every unit of the consumable resource that is consumed.

17. The method of claim 11, further including generating a baseline value based on the emission estimate.

18. The method of claim 17, further including generating a comparison between the emissions estimate and a baseline.

19. The method of claim 17, further including generating a reduction goal based on the emissions estimate and a baseline.

20. A system for estimating emissions based on bills paid through a bill paying service, comprising:
a bill payment means configured to receive a bill for an external entity and arrange for a payment based on the bill;
an emission estimation means configured to generate an emission estimate based on the bill; and
a reporting means configured to provide the emission estimate.

21. The system of claim 20, wherein the bill is based on an amount of a consumable resource provided to a location.

22. The system of claim 21, wherein the emissions estimate is generated by multiplying an emissions factor with the amount of the consumable resource provided to the location.

23. The system of claim 22, wherein the emissions factor is based on one or more characteristics of the location.

24. The system of claim 22, wherein the emissions factor is based on the type of the consumable resource.

25. The system of claim 24, wherein the emissions factor is an amount of greenhouse gases produced for every unit of the consumable resource that is consumed.

26. The system of claim 20, where the reporting means includes a web-based interface configured to display the emissions estimate.

27. The system of claim 20, wherein the emissions estimation mean is further configured to generate a baseline value based on the emission estimate.

28. The system of claim 27, wherein the emissions estimation means is further configured to generate a comparison between the emissions estimate and a baseline.

29. The system of claim 27, wherein the emissions estimation means is further configured to generate a reduction goal based on the emissions estimate and a baseline.
